(19) United States
(12) Patent Application Publication
(10) Pub. No.: US 2011/0223458 A1
(43) Pub. Date: Sep. 15, 2011

(54) Power Cell Array Receiver

(75) Inventor: Robert R. Ferber, JR., Woodside, CA (US)

(73) Assignee: Electronvault, Inc.

(21) Appl. No.: 12/724,364

(22) Filed: Mar. 15, 2010

(51) Int. Cl. H01M 2/10

(52) U.S. Cl. 429/99

(57) ABSTRACT

The present invention is directed to power cell array receivers having one or more containment panels having apertures configured to receive a power cell within each hole. Preferably, the PCARs are included in energy systems.

### CROSS-REFERENCE TO RELATED APPLICATIONS

This application is related to application Ser. No. 12/______ (titled “Modular Interconnection System), Ser. No. 12/______ (titled “Impedance Balancer”), and Ser. No. 12/______ (titled “Variable Energy System”), each filed on Mar. 15, 2010, and each of which are incorporated herein by reference in their entirety.

### TECHNICAL FIELD

The present invention relates generally to holders or receivers configured to house one or more power cells, particularly in an energy system.

### BACKGROUND

Large format energy systems are constructed from many cells. These cells are typically electrically connected together to form an electrical configuration of cells. The connected cells, when operating together, can form an energy system. Currently there is growing demand for large format energy systems, particularly within the electric transportation movement realized around the world.

### BRIEF SUMMARY

Various example embodiments of the present invention provide a power cell array receiver (hereinafter “PCAR”) that beneficially can be incorporated into an energy system. PCARs, according to some example embodiments, include one or more containment panels preferably having a plurality of apertures configured to receive power cells. In certain example embodiments, the PCAR includes a pair of side panels and end panels that are positioned substantially perpendicular to and encircle the containment panels. In certain preferred embodiments, one or more of the side panels or end panels include openings formed therein to allow for the passage of a cooling fluid, such as ambient air, by the power cells received in the apertures of the containment panels. Additionally, PCARs, according to example embodiments, can comprise one or more containment panels attached to an inside location of a housing, such as a housing for an energy system. In certain example embodiments, the containment panels are releasably attached to the inside of an integral housing having opposing sides and ends. A lid and bottom panel can be attached, preferably releasably attached, so as to define an internal cavity in which the containment panels are housed.

In certain preferred embodiments, the PCAR comprises two corresponding containment panels. The containment panels are positioned in a parallel spaced apart relation to one another such that a power cell is secured by a first aperture of the first containment panel and a corresponding first aperture of the second containment panel.

### BRIEF DESCRIPTION OF THE SEVERAL VIEWS OF THE DRAWINGS

Reference will now be made to the accompanying drawings, which are not necessarily drawn to scale, and wherein:

FIG. 1 illustrates a top view of an assembled PCAR according to one example embodiment of the present invention;

FIG. 2A is an end view of FIG. 1;

FIG. 2B is an end view of FIG. 1 with an array of power cells positioned within apertures of containment panels;

FIG. 3 illustrates a pair of corresponding containment panels each having multiple apertures according to one example embodiment of the present invention;

FIG. 4 is a view of the inside surfaces of a pair of side panels according to one example embodiment of the present invention;

FIG. 5 is a view of the outside surfaces of the pair of side panels shown in FIG. 4;

FIG. 6 illustrates a PCAR having opposing end panels, bus bars, and terminals located outside one of the end panels according to one example embodiment of the present invention;

FIG. 7 illustrates the partial enclosure of a PCAR by the securing of a top lid in a substantially parallel relationship with the containment panels according to one example embodiment of the present invention;

FIG. 8A illustrates a PCAR in which containment panels having apertures for receiving power cells are secured to the inside of an integral energy system housing;

FIG. 8B illustrates the PCAR shown in FIG. 8A having an array of power cells disposed within the apertures of the containment panels; and

FIG. 9 illustrates the positioning of containment panels relative to other component of an energy system.

### DETAILED DESCRIPTION

Example embodiments of the present invention now will be described more fully hereinafter with reference to the accompanying drawings, in which some, but not all embodiments of the invention are shown. Indeed, this invention may be embodied in many different forms and should not be construed as limited to the embodiments set forth herein. As used in the specification, and in the appended claims, the singular forms “a”, “an”, “the”, include plural referents unless the context clearly dictates otherwise. Like numbers refer to like elements throughout.

Terms such as “substantially,” “about,” “approximately” or the like as used in referring to a relationship between two objects is intended to reflect not only an exact relationship but also variances in that relationship that may be due to various factors such as the effects of environmental conditions, common error tolerances or the like. It should further be understood that although some values or other relationships may be expressed herein without a modifier, these values or other relationships may also be exact or may include a degree of variation due to various factors such as the effects of environmental conditions, common error tolerances or the like.

As used herein, “power cell” refers substantially to energy storage or generation devices including all types of electrochemical cells, electrostatic cells and/or hybrid combinations thereof. For instance “power cell” can include, but is not limited to, a lithium ion battery, lead acid, ultracapacitor, and fuel cells. In certain embodiments, “power cell” can also refer to energy generation devices such as a solid state device that produces electrical energy by conversion from another form of energy such as a solar photovoltaic cell, Peltier junction device, thermopile device or other solid state energy conversion cell.

As used herein, “energy system” refers to an assemblage of power cells capable for storing, generating, or releasing energy.

In general, PCARs according to embodiments of the present invention can include at least one containment panel having one or more apertures configured to receive a respective power cell. A PCAR, according to one example embodiment of the present invention, can also include one or more side panels and/or one or more end panels that are attached substantially perpendicular to the containment panels. As such, the outer edges of the containment panels are encircled by the side and end panels. In some embodiments, one or more of the side panels and/or end panels include one or more openings formed therein to allow for the passage of a cooling fluid over the outer surface of power cells received in the apertures of the containment panels. In certain example embodiments, the PCAR comprises one or more containment panels attached directly or indirectly to at least one inside location of a housing, such as a housing for an energy system. In certain example embodiments, the containment panels are releasably attached (e.g., bolted or screwed into position) to the inside of an integral housing having opposing sides and ends. A lid and bottom panel can be attached, preferably releasably attached, so as to define an internal cavity in which the containment panels are housed. In certain preferred embodiments, the PCAR comprises two corresponding containment panels. The containment panels are positioned in a parallel spaced apart relation to one another such that a power cell is received and/or secured by a first aperture of the first containment panel and a corresponding first aperture of the second containment panel.

In certain embodiments, the PCAR includes one or more power cells disposed within one or more of the apertures of the containment panels. In one embodiment, a power cell is disposed within each and every aperture such that PCAR is completely loaded with power cells. In certain embodiment, however, a PCAR can beneficially be partially loaded. That is, at least one of the apertures (or corresponding set of apertures) does not have a power cell disposed therein. Accordingly, additional power cells can be loaded into the PCAR at a later time.

In certain embodiments according to the present invention, each containment panel of the PCAR includes one or more tiling sections. Each tiling section includes a respective set of apertures. In some embodiments, each of the tiling sections comprise apertures arranged in a grid pattern, for example, a hexagonal grid, rectangular grid, square pitch grid, or triangular grid. For instance, the containment panels can include multiple (e.g., 2, 3, 4, 5, 6, 7, 8, etc.) tiling sections each having the same or different aperture arrangement. That is, all tiling sections can have the same aperture arrangement (e.g., hexagonal grid) or each tiling section can have a unique aperture arrangement. For example, a containment panel can have a first tiling section comprising a hexagonal grid aperture arrangement and a second tiling section comprising a triangular aperture arrangement. Further, all apertures within a tiling section need not be identical in shape or size with any other tiling section of the containment panel.

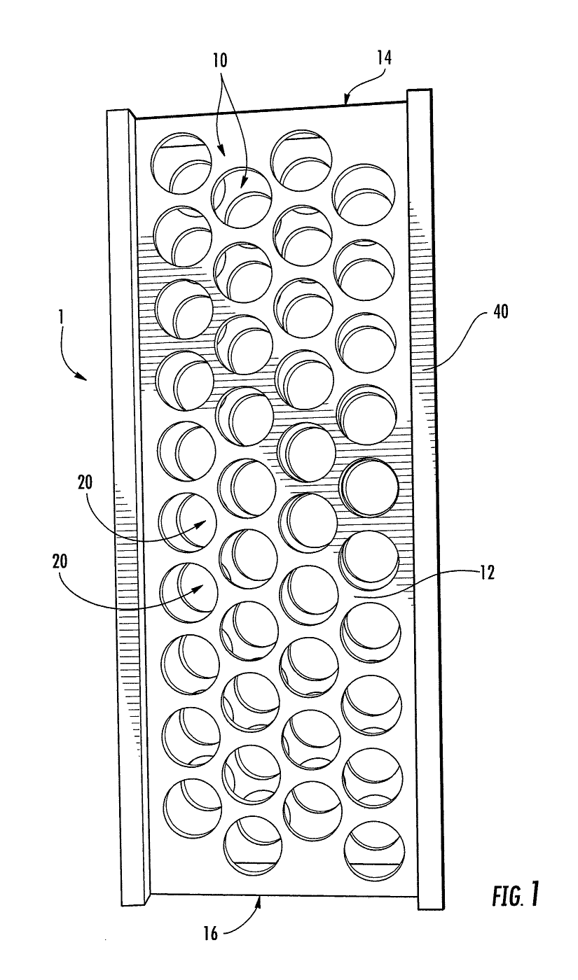

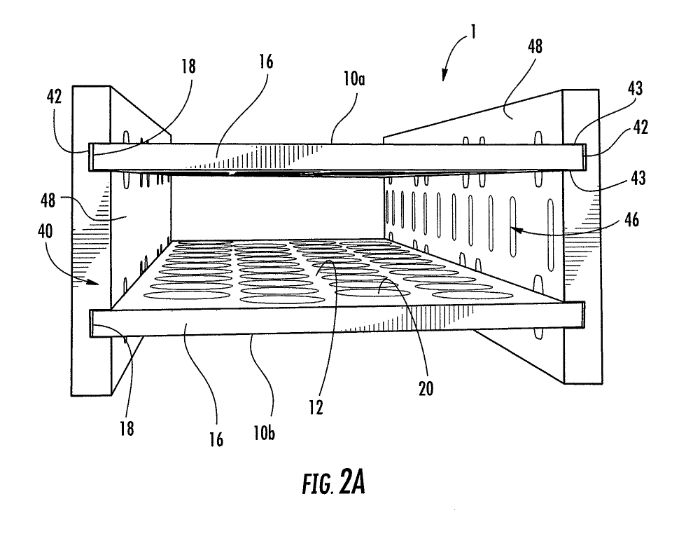

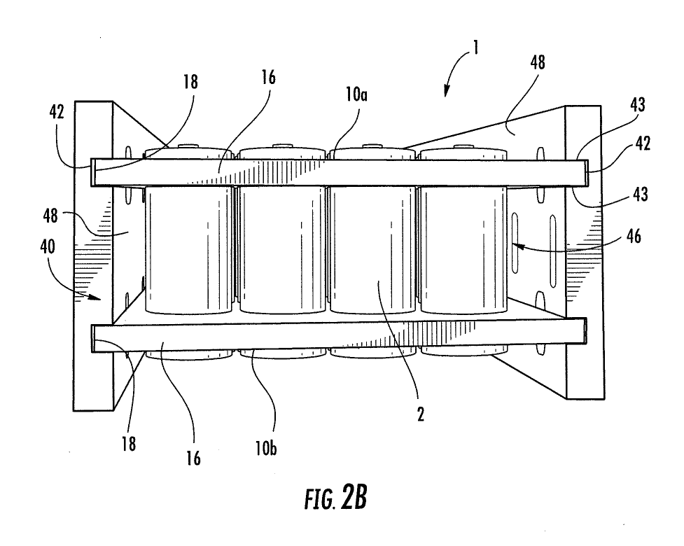

FIG. 1 illustrates a top view of a PCAR 1 according to one example embodiment of the present invention. In FIG. 1, the PCAR 1 comprises a pair of containment panels 10 and a pair of side panels 40. Each of the containment panels 10 include a plurality of circular apertures 20 formed in the panels such that a power cell can be received in each corresponding pair of apertures. As shown in FIG. 2A, the PCAR 1 according to this particular example embodiment is configured such that the containment panels 10 (i.e., 10a, 10b) are parallel to one another and substantially perpendicular to the side panels 40. FIG. 2B illustrates the positioning of an array of power cells 2 in the respective apertures of the containment panels 10a, 10b. In this particular example embodiment illustrated in FIGS. 2A and 2B, the side panels 40 include recessed portions 42 each defining a channel configured to receive respective side edges 18 of the containment panels. As shown in FIGS. 2A and 2B, the recessed portions 42 define a substantially U-shaped channel having side walls 43 that are substantially parallel to each other.

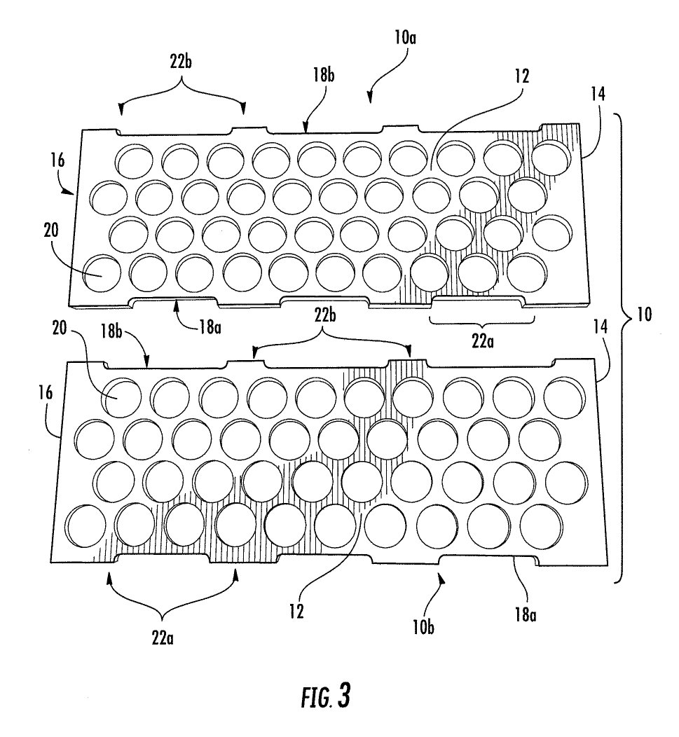

FIG. 3 illustrates a pair of corresponding containment panels (e.g., a first and second containment panel) 10a, 10b, each having a central body portion 12 with a top edge 14, a bottom edge 16, and opposing side edges 18. Additionally, each containment panel 10 includes multiple apertures 20 and protrusions 22 extending from respective side edges 18 of the containment panels. Preferably, the recessed portions 42 of the side panels 10 and the protrusions 22 of the containment panels are configured such that the protrusions of the containment panels can be received by the recessed portions of the side panels. Upon insertion of the protrusions 22 into the recessed portions 42, the containment panels 10 are secured to the side panels 40 such that the containment panels are positioned with the two central body portions 12 in parallel spaced apart relation to one another. In this example embodiment, a power cell can be secured and/or received by a first aperture of the first containment panel and a corresponding first aperture of the second containment panel.

As shown in FIG. 3, the apertures 20 of the containment panels 10 can be arranged in a hexagonal grid. In certain embodiments, the apertures 20 can be arranged a different grid pattern such as a rectangular grid. In one particular example embodiment the apertures 20 can be provided in a different grid pattern such as a square pitch grid. In one example embodiment, the apertures 20 can be arranged in any of a variety of grid patterns or tessellations. Although FIG. 3 depicts the apertures as being circular, the geometric shape of the apertures is not particularly limited according to certain embodiments of the present invention. By way of example only, the apertures can be square, oval, prismatic, etc.

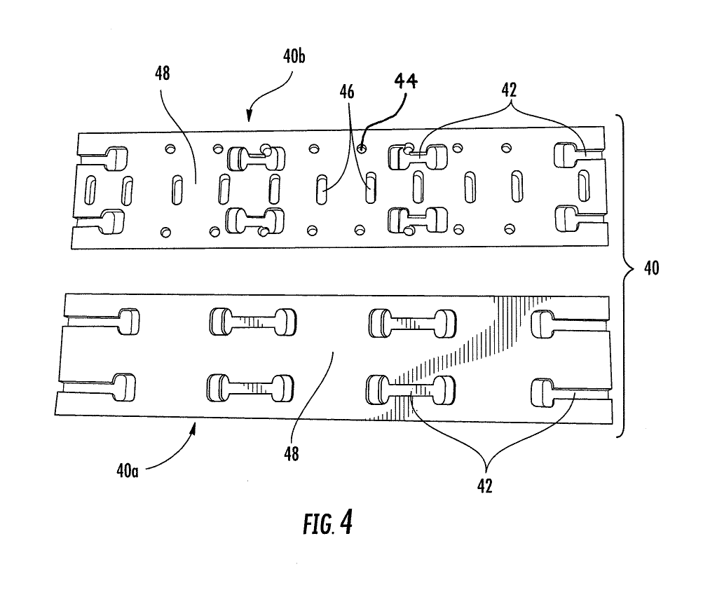

Accordingly, one example embodiment includes one or more containment panels (e.g., 1, 2, 3, 4, etc.), attached to a pair of side panels. Preferably, the side panels are directly and releasably attached to the side edges of the containment panels in a substantially perpendicular manner so that the central body portions of the containment panels are positioned between and substantially perpendicular to the side panels. More preferably, the side panels each include several recessed portions located on the inside surface of the side panels to receive each of the protrusions of the containment panels. For instance, FIG. 4 provides a view of the inside surface 48 of a pair of side panels 40. In this particular example embodiment, each side panel 40 includes a plurality of recessed portions 42 configured to receive a respective protrusion 22 from a containing panel 10. In this particular example embodiment, the inside surface 48 of each side panel 40 include four recessed portions 42 for securing a first containment panel and four recessed portions 42 for securing a second containments panel 10 such that the central body portions 12 of the containment panels 10 are substantially parallel to each other. As illustrated in FIG. 4, a first side panel 40a can include recessed portions 42 larger (e.g., twice as long) than the recessed portions 42 of the second side panel 40b. Accordingly, as shown in FIG. 3, each of the containment panels 10 can include longer protrusions 22a on a first side edge 18a corresponding to the longer recessed portions of the first side panel 40a and shorter protrusions 22b on a second side edge 18b corresponding to the shorter recesses of the second side panel 40b. That is, the longer protrusions on the first side edge or each containment panel are positioned into the corresponding longer recessed portions of the first side panel. Similarly, the shorter protrusions on second side edge of each containment panel are positioned into the corresponding shorter recessed portions of the second side panel. Such a configuration allows for quick and easy assembly of the PCAR and helps ensure proper alignment of the respective apertures of the containment panels. If desired, such example embodiments can be positioned within a larger housing and optionally affixed to the inside of the housing. Depending on the desired design for the intended energy system, however, such example embodiments can be used independently of a separate housing.

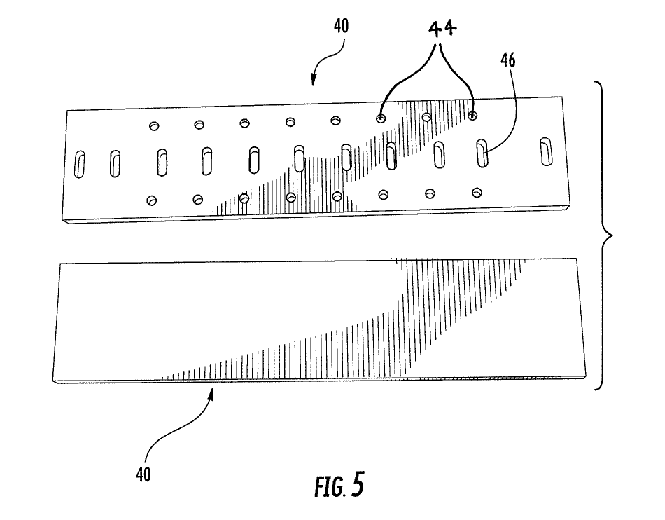

As shown in FIGS. 4 and 5, this particular embodiment includes several openings 44,46 formed in the second side panel 40b. The provided openings 44 and/or openings 46 enable the use of a cooling fluid for dissipating heat generated by power cells received in the containment panels. Additionally, openings 44 and/or openings 46 can also define throughways for wiring or sensors as needed for particular applications. Despite this example embodiment showing a plurality of openings only in one of the side panels, it should be understood that each side panel and each end panel can have one or more openings formed therein. For example, if it was desirable to convey or allow for the passage of a cooling fluid (e.g., air) to enter through one end panel and out the opposing end panel, then the side panels would not include any such openings. In such an embodiment, however, each of the end panels would include one or more openings for passage of a cooling fluid.

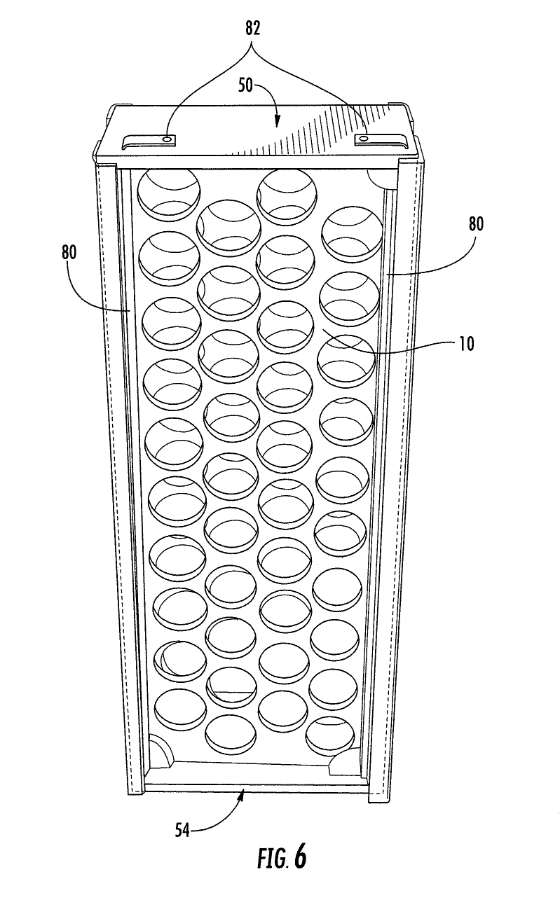

FIG. 6 illustrates a PCAR 1 having a first end panel 50 attached to the top edges of the containment panels 10 and a second end panel 54 attached to the bottom edges of the containment panels. As shown in FIG. 6, the central body portions 12 of the containment panels 10 are positioned between and substantially perpendicular to the end panels 50, 54 and the side panels 40. That is, the end panels 50, 54 and side panels 40 “box-in” and secure the containment panels 10 in place so that they do not move. Although this particular embodiment shows containment panels encircled and secured by side and end panels, it should be noted that various alternative example embodiments can comprise containment panels secured in a substantially parallel orientation with respect to each other by means of one or more connecting rods that extend from one containment panel to a different containment panel. For example, a single connecting rod can have a proximate end and a distal end. The proximate end of the connecting rod can be attached, preferably releasably attached, to a first containment panel and the distal end of the connecting rod can be attached, preferably releasably attached, to a second containment panel. In preferred embodiments, the connected containment panels are secured in a substantially parallel relationship to each other.

As also shown in FIG. 6, example embodiments according to the present invention can preferably include one or more bus bars 80 affixed to one or both of the side panels 40 or containment panels 10. The particular material and geometry of the bus bars is not particularly limited. For example only, the bus bars can be either flat strips or hollow tubes and comprise a conductive material such as copper or aluminum. In certain example embodiments, each bus bar may either be supported on insulators or insulation can be provided to encircle portions of the bus bar which are not electrically connected (directly or indirectly) to the power cells. Such example embodiments can also include terminals either integral to the bus bars or electrically connected thereto. In the example embodiment illustrated in FIG. 6, the terminals 82 are mounted on the outside of end panel 50.

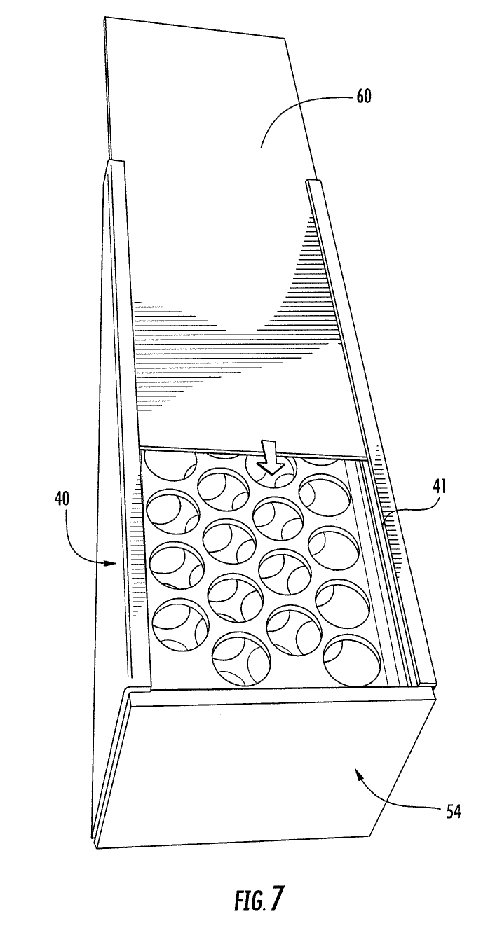

FIG. 7 illustrates the partial enclosure of a PCAR according to one example embodiment of the present invention. More specifically, FIG. 7 shows one particular example embodiment in which each of the side panels 40 also includes a groove 41 for receiving a lid 60 that can be slid into position from one end of the PCAR to another. Although not shown, a bottom panel can also be attached in a similar manner. Preferably, the lid and the bottom panel are attached substantially perpendicular to the side panels and end panels to define a housing having an interior cavity. Accordingly, the containment panels are housed and secured within the internal cavity defined by the housing. Although FIG. 7 illustrates attachment of the lid 60 (and bottom panel) by sliding the lid into place with the assistance of grooves 41 in the side panels 40, it should be clear that the lid and bottom panel can be secured in any manner that will result in the encasing of the containment panels within an interior cavity. For example only, the lid and bottom can be screwed, snapped, or bolted in place.

In one preferred embodiment, the PCAR includes one or more containment panels. Each panel includes a central body portion with a top edge, a bottom edge, and opposing side edges. As discussed previously, each of the containment panels include one or more apertures configured to receive a power cell within each aperture. Preferably, each containment panel can include multiple apertures arranged in a hexagonal grid. Each of the containment panels is positioned such that all of the central body portions of the containment panels are in a parallel spaced apart relation to one another. Accordingly, a power cell can be received by a first aperture of a first containment panel, a corresponding first aperture of a second containment panel, and a first aperture of a third containment panel. If desired, however, a single containment panel can be utilized.

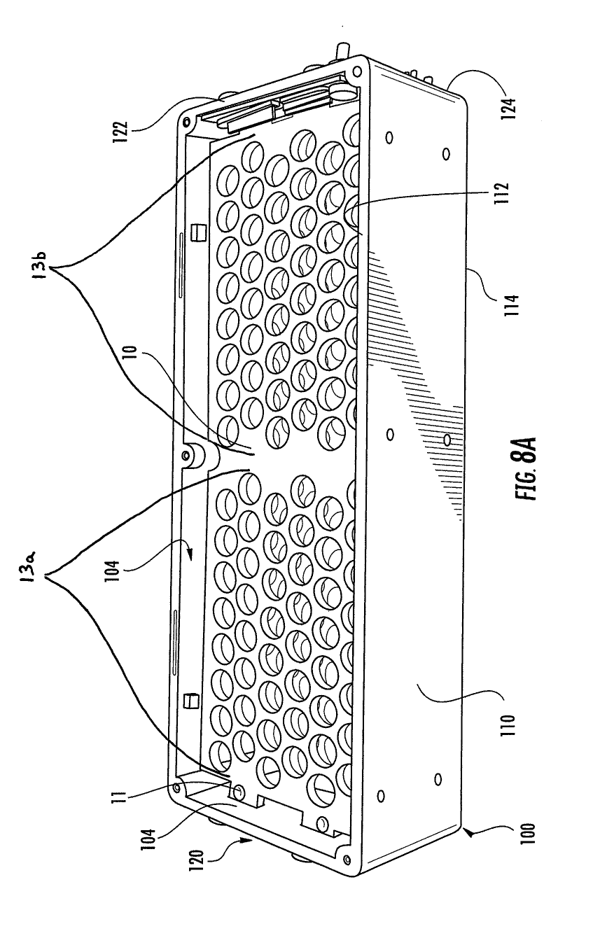

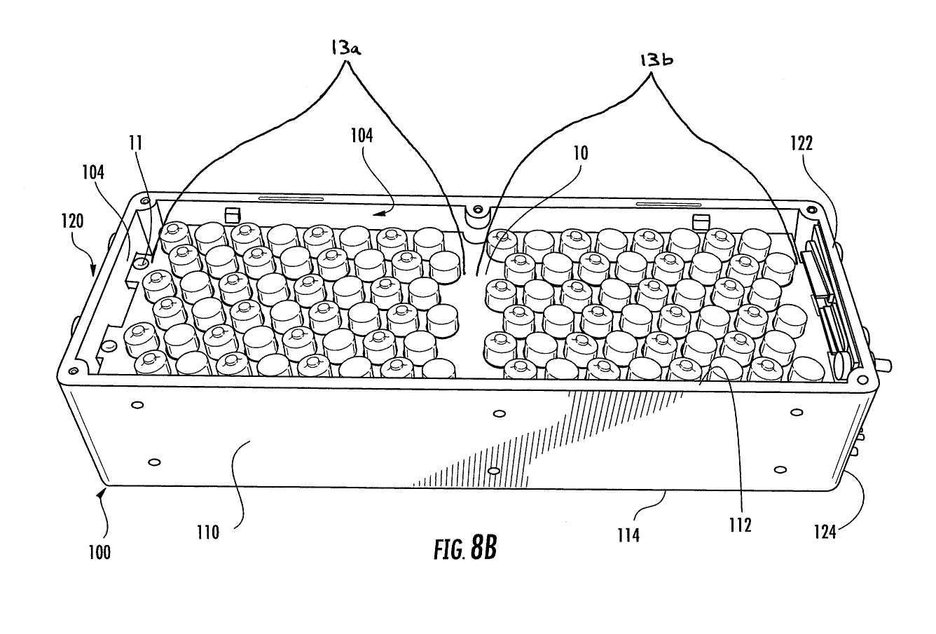

In another aspect, example embodiments of the present invention provide PCARs comprising one or more containment panels attached to at least one inner portion of a separate housing. For instance, FIG. 8A shows one such embodiment. In this particular example embodiment, the housing 100 includes a pair of opposing side panels 110 and a pair of opposing end panels 120, which are integral. That is, the housing 100 in this particular example embodiment is a single component. The housing 100, however, need not be a single component. For example, each of the panels can be releasably attached to one another to form a structurally similar housing. In the example embodiment shown in FIG. 8A, the containment panels 10 are attached to at least one inside portion 104 of the housing by bolts 11, screws, or the like. The attachment of the containment panels, however, is not particularly limited. Preferably, the containment panels are releasably attached to the housing. FIG. 8B illustrates one such embodiment in which an array of power cells 2 are disposed within respective apertures of the containment panels 10. As such, the power cells 2 are housed within the PCAR.

As shown in FIGS. 8A and 8B, this particular embodiment includes a first tiling section 13a having apertures 20 arranged in a hexagonal grid and a second tiling section 13b having apertures 20 arranged in a hexagonal grid. Although the particular embodiment shown in FIGS. 8A and 8B show containment panels having two tiling sections each having apertures arranged in a hexagonal grid, the number or tiling sections is not particularly limited according to certain embodiments of the present invention. For example only, the containment panels can include 1-500 tiling sections (e.g., 1-400, 1-300, or 1-200). Further, if there are two containment panels operable together, one containment panel can have a different number of tiling sections or aperture arrangements from the second. Additionally, in some embodiments each of the tiling sections can comprise apertures arranged in a grid pattern or tessellation, for example, in a hexagonal grid, rectangular grid, square pitch grid, or triangular grid. For instance, all tiling sections can have the same aperture arrangement (e.g., hexagonal grid) or each tiling section can have a unique aperture arrangement. For example, a containment panel can have a first tiling section comprising a hexagonal grid aperture arrangement and a second tiling section comprising a triangular aperture arrangement. Further, all apertures within a tiling need not be identical in shape or size. Similarly, apertures of different tiling sections need not be identical in shape or size with any other tiling section of the containment panel.

In one alternative example embodiment, the containment panels are physically bonded to the housing by an adhesive or the like. Preferably, the containment panels are attached to the housing such that each respective central body portion of the containment panel is positioned substantially perpendicular to the opposing side panels and opposing end panels of the housing. In another alternative example embodiment, the containment panels are integral with the housing. For example, the containment panels and the housing can be molded as a single component by customary molding processes, such as injection molding or resin transfer molding among others.

In one example embodiment, the PCAR includes a pair of containment panels (i.e., a first and second containment panels). Each containment panel is releasably attached to more than one inside portion of a separate housing. Each of the first and second containment panels includes a respective central body portion with a top edge, a bottom edge, opposing side edges. Both the first and second containment panels include several (e.g., 5-100) apertures configured to receive a power cell in each aperture. Preferably, the apertures in each of the containment panels are arranged in a hexagonal grid such that a power cell can be received by a first aperture of the first containment panel and a corresponding first aperture of a second containment panel. Although not necessary, the containment panels are preferably positioned with the housing such that the central body portions of the two containment panels are substantially in parallel spaced apart relation to one another. In alternative example embodiments, the containment panels secured to the interior of the housing include apertures arranged in a rectangular grid, a square pitch grid, or a triangular grid.

In yet another example embodiment, the housing can include one or more openings formed therein. For example, one or more openings can be formed in one or more of the opposing side panels, opposing end panels, or combination thereof. Beneficially, such openings can allow passage of a cooling fluid into and out of the housing to provide a medium for removing heat from the power cells. In certain example embodiments, the cooling fluid can be ambient air. The cooling fluid, however, is not particularly limited as long as the cooling medium is chemically compatible with the energy system.

In one preferred embodiment, the PCAR includes a first containment panel, having a central body portion with a top edge, a bottom edge, and opposing side edges. The first containment panel includes a plurality of apertures arranged in a hexagonal grid configured to receive a power cell within each aperture. The PCAR also includes a second containment panel having a central body portion with a top edge, a bottom edge, and opposing side edges. The second containment panel includes the same number of apertures as the first containment panel and each aperture is configured to receive a respective power cell. The apertures in the second containment panel correspond to the apertures in the first containment panel. That is, the apertures in the second containment panel are arranged in an identical hexagonal grid as the apertures in the first containment panel. The first and second containment panels are positioned such that the central body portions of each containment panel are in a parallel spaced apart relation to one another. With such a relationship between the two containment panels, a power cell can be received by a first aperture of the first containment panel and a corresponding first aperture of the second containment panel. Preferably, each containment panel is attached to at least one inner portion of a separate housing having a pair of opposing side panels and a pair of opposing end panels, such that the central body portion of each containment panel is positioned substantially perpendicular to the opposing side panels and opposing end panels of the housing. Additionally, as shown in FIGS. 8A and 8B, each side panel 110 and each end panel 120 of the housing includes a top edge 122,112 and a bottom edge 114,124. That is, FIGS. 8A and 8B illustrate that each side panel 110 includes a top edge 112 and a bottom edge 114 and each end panel 122 includes a top edge 122 and a bottom edge 124. To enclose the PCAR, a bottom panel is attached to the bottom edges of the side panels and end panels of the housing and a top panel or lid is attached to the top edges of the side panels and end panels of the housing. Preferably, the bottom panel and/or the lid are releasably attached to the housing to allow easy access to the containment panels. Such embodiments, for instance, allow for easy access to the containment panels for adding new power cells and removing exhausted power cells without the need of replacing the entire component.

The PCARs according to example embodiments of the present invention can be assembled from a wide variety of materials. Preferably, however, each component (e.g., containment panels, side panels, housing, etc.) is formed from a polyermic material (e.g., thermoplastic or thermoset polymer or copolymer) that exhibits a desirable degree of impact strength and heat resistance. In certain example embodiments, the polymeric material comprises a cured thermoset. In such example embodiments, deformation of each component due to heat is mitigated by the use of a thermosetting polymer.

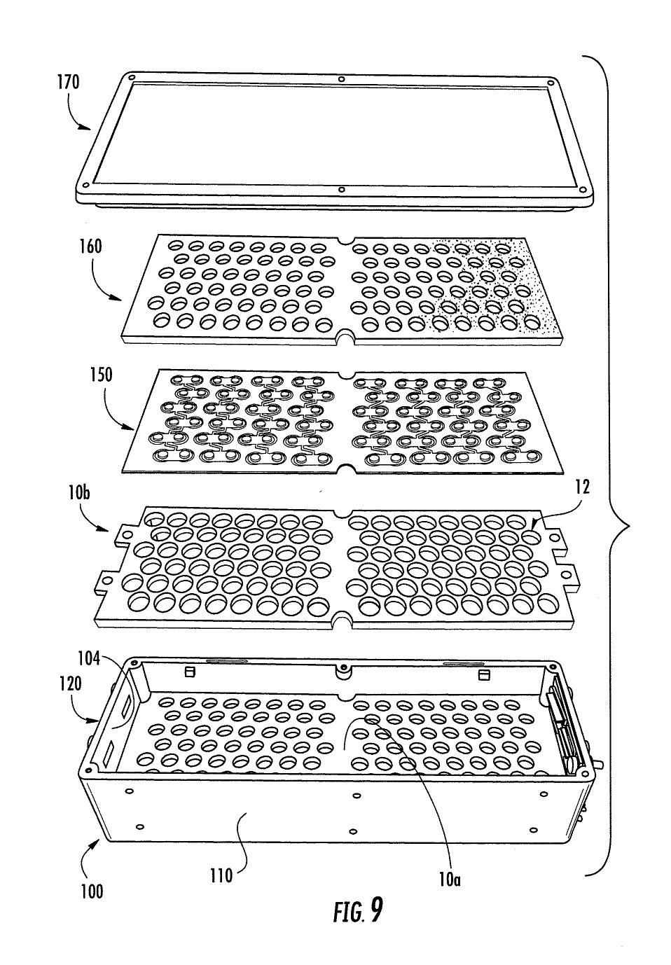

PCARs according to example embodiments of the present invention are particularly well suited for inclusion into a variety of energy systems. As seen in FIG. 9, a first containment panel 10a and second containment panel 10b can be releasably attached to a separate housing 100 such that one or more power cells can be received and secured therein. After attaching the respective containment panels 10a,10b into the desired position, one or more power cells can be disposed within the containment panels. That is, a single power cell can be disposed with in a pair of corresponding apertures 20 as discussed previously. Once the power cells are in position, a releasable modular interconnect 150 can be positioned over the top of the power cells to connect the power cells together. Generally, a releasable modular interconnect 150 comprises conductive members having contact that act to connect the power cells together in order to allow current to flow to/from the power cells. According to one example embodiment, rather then utilizing a releasable modular interconnect to connect the cells, the cells may be connected via soldering, tack welding or the like. In certain example embodiments, an electrical connection between the releasable modular interconnect 150 and the power cells is achieved by disposing an electrically conductive paste or grease between the terminals of the power cells and electrical contacts of the releasable modular interconnect. Although not shown, the releasable modular interconnect can be operatively connected to one or more bus bars. The bus bars, preferably, can be mounted on or proximate to the containment panels or on the sides housing. After the power cells are connected to the releasable modular interconnect 150, a shock absorbing cushion 160, may be positioned over the releasable modular interconnect. Finally, a lid 170 is releasably attached to the housing to provide an enclosed energy system. Although not illustrated in FIG. 9, the bottom half of the energy storage is configured the same way.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A power cell array receiver (“PCAR”), comprising:
one or more containment panels each having a central body portion with a top edge, a bottom edge, opposing side edges, and one or more apertures configured to receive a power cell within each aperture.

2. A PCAR according to claim 1, comprising two or more containment panels, wherein each of said containment panels are positioned with said central body portions in parallel spaced apart relation to one another such that a power cell can be received by a first respective aperture of each containment panel.

3. A PCAR according to claim 1, further comprising one or more power cells disposed within said one or more apertures.

4. A PCAR according to claim 3, wherein a power cell is disposed within each and every aperture.

5. A PCAR according to claim 3, wherein at least one of the apertures does not have a power cell disposed therein, such that additional power cells can be loaded into the PCAR at a later time.

6. A PCAR, comprising:
one or more containment panels, each having a central body portion with a top edge, a bottom edge, opposing side edges, and one or more apertures configured to receive a power cell within each aperture; and
a pair of side panels each attached to respective side edges of the one or more containment panels, such that the central body portion of the one or more containment panels is positioned between and substantially perpendicular to the side panels.

7. The PCAR according to claim 6, wherein the pair of side panels each include one or more recessed portions defining one or more channels configured to receive the side edges of the one or more containment panels.

8. The PCAR according to claim 7, wherein the side edges of the one or more containment panels include protrusions corresponding to said recessed portions of the side panels, said protrusions are positioned in said recessed portions.

9. The PCAR according to claim 6, further comprising a first end panel attached to the top edges of the one or more containment panels and a second end panel attached to the bottom edges of the one or more containment panels such that the central body portion of the at least one containment panels is positioned between and substantially perpendicular to the end panels and the side panels.

10. The PCAR according to claim 9, further comprising a lid and a bottom panel, both the lid and the bottom panel are attached substantially perpendicular to the side panels and end panels to define a housing having an interior cavity.

11. The PCAR according to claim 10, including one or more openings formed in one or more of said side panels, end panels, or combination thereof, such that a cooling fluid can be conveyed into and out of the housing to provide a medium for removing heat generated from power cells disposed within the apertures of the one or more containment panels.

12. The PCAR according to claim 6, wherein the apertures are arranged in a hexagonal grid.

13. The PCAR according to claim 6, wherein the apertures of each containment panel are arranged in one or more tiling sections, said tiling sections each comprise a respective set of apertures.

14. The PCAR according to claim 13, wherein each of the one or more tiling sections comprise apertures arranged in a grid pattern or tessellation.

15. The PCAR according to claim 14, wherein all of the one or more tiling sections comprise the same aperture arrangement.

16. The PCAR according to claim 6, further comprising one or more bus bars positioned proximate to the one or more containment panels.

17. The PCAR according to claim 6, comprising:
a first containment panel, having a central body portion with a top edge, a bottom edge, opposing side edges, and one or more apertures configured to receive a power cell within each aperture;
a second containment panel having a central body portion with a top edge, a bottom edge, opposing side edges, and one or more apertures configured to receive a power cell within each aperture; and
said containment panels being positioned with said central body portions in parallel spaced apart relation to one another such that a power cell is received by a first aperture of the first containment panel and a corresponding first aperture of the second containment panel.

18. The PCAR according to claim 17, wherein the apertures are arranged in a hexagonal grid.

19. A power cell array receiver (“PCAR”), comprising:
at least one containment panel having a central body portion with a top edge, a bottom edge, opposing side edges, and one or more apertures configured to receive a power cell within each aperture;
the at least one containment panel is attached to at least one inner portion of a housing, said housing having a pair of opposing side panels and a pair of opposing end panels; and
said central body portion of the at least one containment panel is positioned substantially perpendicular to the opposing side panels and opposing end panels.

20. The PCAR according to claim 19, comprising:
a first containment panel, having a central body portion with a top edge, a bottom edge, opposing side edges, and one or more apertures configured to receive a power cell within each aperture;
a second containment panel having a central body portion with a top edge, a bottom edge, opposing side edges, and one or more apertures configured to receive a power cell within each aperture; and
said containment panels being positioned with said central body portions in parallel spaced apart relation to one another such that a power cell is received by a first aperture of the first containment panel and a corresponding first aperture of the second containment panel.

21. The PCAR according to claim 19, wherein the containment panels are releasable attached to the at least one inner portion of a housing.

22. The PCAR according to claim 19, wherein the apertures are arranged in a grid pattern or tessellation.

23. The PCAR according to claim 19, wherein the apertures of each containment panel are arranged in one or more tiling sections, said tiling sections each comprise a respective set of apertures, and wherein each of the one or more tiling sections comprise apertures arranged in a grid pattern or tessellation.

24. The PCAR according to claim 19, further comprising one or more power cells disposed within said one or more apertures.

25. A PCAR according to claim 19, wherein one or more of the apertures does not have a power cell disposed therein, such that additional power cells can be loaded into the PCAR at a later time.

26. The PCAR according to claim 19, further comprising one or more bus bars positioned proximate to the one or more containment panels.

27. The PCAR according to claim 19, wherein the housing includes one or more openings formed in one or more of the opposing side panels, opposing end panels, or combination thereof, such that a cooling fluid can be conveyed into and out of the housing to provide a medium for removing heat generated from power cells disposed within the apertures of the one or more containment panels.

28. A power cell array receiver (“PCAR”), comprising:
a first containment panel, having a central body portion with a top edge, a bottom edge, opposing side edges, and one or more apertures configured to receive a power cell within each aperture;
a second containment panel having a central body portion with a top, a bottom, opposing side edges, and one or more apertures configured to receive a power cell within each aperture;
said containment panels being positioned with said central body portions in parallel spaced apart relation to one another such that a power cell is secured by a first aperture of the first containment panel and a corresponding first aperture of the second containment panel;
each containment panel being attached to at least one inner portion of a housing, said housing having a pair of opposing side panels and a pair of opposing end panels, wherein each side panel and each end panel include a top edge and a bottom edge;
said central body portion of each containment panel is positioned substantially perpendicular to the opposing side panels and opposing end panels;
a bottom panel attached to the bottom edges of the side panels and end panels; and
a top panel attached to the top edges of the side panels and end panels.

29. The PCAR according to claim 28, wherein the apertures are arranged in a hexagonal grid.

30. The PCAR according to claim 28, wherein the apertures of each containment panel are arranged in one or more tiling sections, said tiling sections each comprise a respective set of apertures, and wherein each of the one or more tiling sections comprise apertures arranged in a grid pattern or tessellation.

31. The PCAR according to claim 28, wherein the opposing side panels and opposing end panels of the housing are integral, such that the housing comprises a single component.

32. The PCAR according to claim 28, further comprising one or more power cells disposed within corresponding apertures of the first and second containment panels.

33. A PCAR according to claim 32, wherein one or more of the apertures does not have a power cell disposed therein, such that additional power cells can be loaded into the PCAR at a later time.

34. The PCAR according to claim 28, further comprising one or more bus bars positioned proximate to the one or more containment panels.
